(19) United States
(12) Patent Application Publication
(10) Pub. No.: US 2015/0032907 A1
(43) Pub. Date: Jan. 29, 2015

(54) UNIVERSAL ADAPTER WITH CONTEXT-BOUND TRANSLATION FOR APPLICATION ADAPTATION LAYER

(71) Applicant: ALCATEL-LUCENT CANADA, INC., OTTAWA (CA)

(72) Inventors: Pradeep Chandra Mekala, Nepan (CA); Ihuoma Onyegbula, Kanata (CA); Meng YAO, Ottawa (CA)

(73) Assignee: ALCATEL-LUCENT CANADA, INC., OTTAWA (CA)

(21) Appl. No.: 13/952,168

(22) Filed: Jul. 26, 2013

(51) Int. Cl. H04L 29/08

(52) U.S. Cl. CPC H04L 67/00
USPC 709/246

(57) ABSTRACT

Various exemplary embodiments relate to a method and related network node including one or more of the following: receiving a first object to be translated, wherein the first object has a first type; obtaining a second object having a second type that is different from the first type; identifying a first property of the first object, wherein the first property is associated with a first location within a hierarchy of the first object; identifying a second property of the second object; setting a value of the second property based on a value of the first property when: a name of the first property matches a name of the second property, and the first location matches a second location of the second property within a hierarchy of the second object; and making the second object available to a receiving device.

### TECHNICAL FIELD

Various exemplary embodiments disclosed herein relate generally to inter-device communications.

### BACKGROUND

Many applications and systems involve varying forms of communication between differing devices. One such communication may involve the transmission of data objects from one device to another. However, in many situations, it is not desirable for a device to simply transmit a data object in the same form as it is used by that device. For example, transmitting such an unmodified object may reveal implementation details of the device, reveal information that should not be shared for privacy reasons, or transmit information in a form that is not recognized by the receiving device. As such, some devices implement interfaces that translate between an internal object for use by the device and an external object that is transmitted to the other device. Devices may include multiple such interfaces to support different applications, receiving devices, and implementation versions.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method performed by a networked device for translating information used in communicating with another device, the method including: receiving a first object to be translated, wherein the first object has a first type; obtaining a second object having a second type that is different from the first type; identifying a first property of the first object, wherein the first property is associated with a first location within a hierarchy of the first object; identifying a second property of the second object; setting a value of the second property based on a value of the first property when: a name of the first property matches a name of the second property, and the first location matches a second location of the second property within a hierarchy of the second object; and making the second object available to a receiving device.

Various embodiments described herein relate to a networked device for translating information used in communicating with another device, the method including: a network interface; a memory; and a processor in communication with the memory and the network interface, the processor being configured to: receive a first object to be translated, wherein the first object has a first type; obtain a second object having a second type that is different from the first type; identify a first property of the first object, wherein the first property is associated with a first location within a hierarchy of the first object; identify a second property of the second object; set a value of the second property based on a value of the first property when: a name of the first property matches a name of the second property, and the first location matches a second location of the second property within a hierarchy of the second object; and make the second object available to a receiving device.

Various embodiments described herein relate to a non-transitory machine-readable storage medium encoded with instructions for execution by a networked device for translating information used in communicating with another device, the medium including: instructions for receiving a first object to be translated, wherein the first object has a first type; instructions for obtaining a second object having a second type that is different from the first type; instructions for identifying a first property of the first object, wherein the first property is associated with a first location within a hierarchy of the first object; instructions for identifying a second property of the second object; instructions for setting a value of the second property based on a value of the first property when: a name of the first property matches a name of the second property, and the first location matches a second location of the second property within a hierarchy of the second object; and instructions for making the second object available to a receiving device.

Various embodiments are described wherein: the receiving device includes another device in communication with the networked device, the first type is a type used internally by a processor of the networked device, and making the second object available includes transmitting the second object to the other device.

Various embodiments are described wherein: the receiving device includes a processor of the networked device, and the second type is a type used internally by the processor.

Various embodiments are described wherein setting a value of the second property based on a value of the first property includes: identifying a first data type of the first property identifying a second data type of the second property; and converting the value of the first property to the second data type when the first data type and the second data type do not match.

Various embodiments are described wherein: obtaining the second object includes obtaining a second object including a previous value for the second property, and setting a value of the second property includes overwriting the previous value.

Various embodiments additionally include: identifying a third property of the first object; identifying a translation binding associated with the third property; identifying, based on the translation binding, a fourth property of the second object, wherein the fourth property does not match the third property; and setting a value of the fourth property based on a value of the third property.

Various embodiments are described wherein: the translation binding identifies a transformation function, and setting a value of the fourth property includes using the transformation function to modify the value of the third property.

Various embodiments are described wherein the transformation function accesses at least one property of the first object other than the third property.

### BRIEF DESCRIPTION OF THE DRAWINGS

In order to better understand various exemplary embodiments, reference is made to the accompanying drawings, wherein:

FIG. 1 illustrates an exemplary network for enabling communication between two devices;

FIG. 2 illustrates an exemplary component diagram of a device including a universal translator;

FIG. 3 illustrates an exemplary hardware diagram of a device including a universal translator;

FIG. 4 illustrates an exemplary data arrangement for storing translation bindings;

FIG. 5 illustrates an exemplary translation from an internal object and an external object;

FIG. 6 illustrates an exemplary method for translating an object;

FIG. 7 illustrates an exemplary method for performing a preregistered translation; and

FIG. 8 illustrates an exemplary method for performing a trivial translation.

To facilitate understanding, identical reference numerals have been used to designate elements having substantially the same or similar structure or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended to be for pedagogical purposes, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

As noted, each application, external device, or interface version supported by a device may be associated with a separate set of code to enable translation between internal objects and appropriate external objects. Creation and maintenance of such separate code for each supported interface may pose a heavy burden on developers. Accordingly, it would be desirable to provide a more universal and easily extensible interface for communicating with external devices using translated objects.

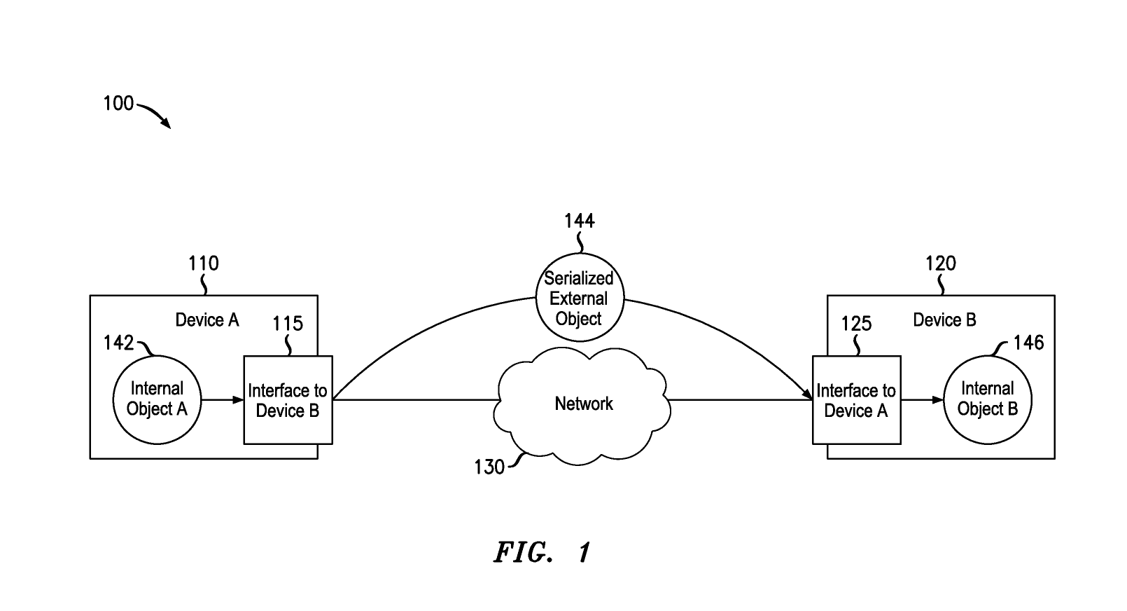

FIG. 1 illustrates an exemplary network 100 for enabling communication between devices. As shown, the exemplary network 100 may include two devices 110, 120 in communication via a network 130. It will be understood that various additional devices (not shown) may also participate in the network 100 by communicating with one or more of the pictured devices 110, 1120.

The devices 110, 120 may each be any networked device configured to transmit or receive objects via the network 130. In various embodiments, each of the devices 110, 120 may be a desktop computer, laptop, tablet, mobile device, server, or blade. The devices 110, 120 may also each include an interface 115, 125, respectively, for enabling communication via the network 130. Such interfaces 115, 125 may each be an interface including hardware or executable instructions encoded on a machine-readable storage medium configured to communicate with at least one other device. The interfaces 115, 125 may include one or more physical ports and may communicate according to one or more protocols such as, for example, TCP, IP, or Ethernet. Further, the interfaces 115, 125 may be configured to perform one or more object translations as will be described below.

The network 130 may be any network of devices or transmission media capable of enabling communication between the various devices of the exemplary network 100. For example, the network 130 may include numerous devices configured to exchange and route data packets toward various destinations. In various embodiments, the network 130 may include the Internet or one or more carrier networks.

As shown, the devices 110, 120 may utilize internal objects 142, 146 in performing various functions. For example, in one exemplary embodiments, device A 110 may be a policy and charging rules node (PCRN) and device B 120 may be a packet data network gateway (PGW), both implemented according to the third generation partnership project (3GPP) long term evolution (LTE) standards. In this example, the PCRN 110 may utilize an internal object A 142 to represent a subscriber session and perform various operations such as service authorization, rule creation, and flow monitoring with reference to the subscriber session object 142. Similarly, the PGW 120 may utilize an internal object B 146 to represent a subscriber session and perform functions such as packet filtering and usage reporting with reference to the subscriber session object 146. The PGW 120 may obtain the data stored in the internal object B 146 from the PCRN 110 as part of the 3GPP application. It will be apparent that this is one example of a network in which the methods and concepts described herein may be practiced, and that various other devices may utilize these methods and concepts.

When the device A 110 determines that object information should be transmitted to the device B 120, the interface 115 may begin by translating the internal object A 142 to an external object format. Such translation may include copying values from the internal object 142 to an outgoing external object, transforming a data type of such values, and other translation operations. The device A 110 may also serialize the outgoing external object to create a serialized external object 144 to be transmitted to the device B 120 over the network 130. For example, the interface 115 may export the object into an XML format suitable for transmission. Various other serialization techniques will be apparent. Further, it will be understood that various embodiments may first serialize the internal object A 142 and then translate the serialized object into the serialized external object 144.

After receiving the serialized external object 144, the interface 125 may perform a translation similar to that performed by the interface 115. For example, the interface 125 may first deserialize the serialized external object and then translate values from the external object into an internal object B 146. It will be apparent that the translation and deserialization steps may be reversed.

According to various embodiments, the translation or serialization steps may be performed by a universal translator implemented in the interface 115 or 125. For example, such a universal translator may implement translation functions in a manner that can be used for many different applications, receiving devices, and interface versions. As will be explained in greater detail below, the interfaces 115, 125 may implement a “trivial translator” that utilizes object descriptions to translate any given object to any other given object based on matching properties of those objects. Further, the interfaces 115, 125 may additionally or alternatively implement a “pre-registered translator” that utilizes user-provided translation bindings to handle special-case translations from one object to another not already handled by the trivial translator. In this manner, the interfaces 115, 125 may include a translator capable of performing virtually any translation regardless of associated application, receiving device, or interface version number without requiring an entirely separate interface for each such combination.

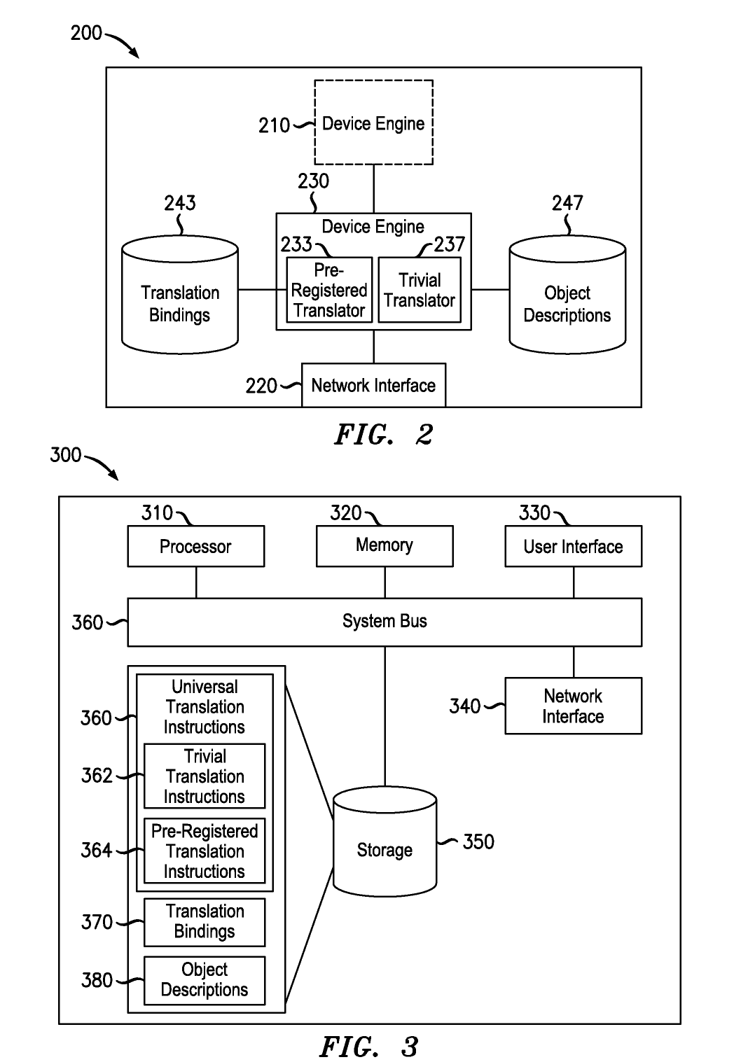

FIG. 2 illustrates an exemplary component diagram of a device 200 including a universal translator. The device 200 may correspond to device A 110 or device B 120 of the exemplary network 100. The device 200 may include a device engine 210, a network interface 220, an universal translator 230, a translation bindings storage 243, and an object descriptions storage 247.

The device engine 210 may include hardware or executable instructions on a machine-readable storage medium configured to perform any functions associated with the device 200 other than object translation. As such, the device engine 210 may incorporate one or more processors configured to achieve the various goals or functions associated with the device. For example, where the device 200 constitutes a PCRN, the device engine 210 may include any components associated with performing functions associated with subscriber authorization, rule creation, or flow monitoring. Various other components or sets thereof for inclusion in the device engine 210 will be apparent and may depend on the nature of the device 200 in which the device engine 210 is incorporated.

The network interface 220 may be an interface including hardware or executable instructions encoded on a machine-readable storage medium configured to communicate with at least one other device. The network interface 220 may include one or more physical ports and may communicate according to one or more protocols such as, for example, TCP, IP, or Ethernet.

The universal translator 230 may include hardware or executable instructions on a machine-readable storage medium configured to enable the device engine 210 to transmit or receive objects with one or more other devices (not shown) via the network interface 220. As such, the universal translator 230 may translate between various internal objects and external objects. The universal translator 230 may utilize multiple translation methods and, as such, may include both a pre-registered translator 233 and a trivial translator 237.

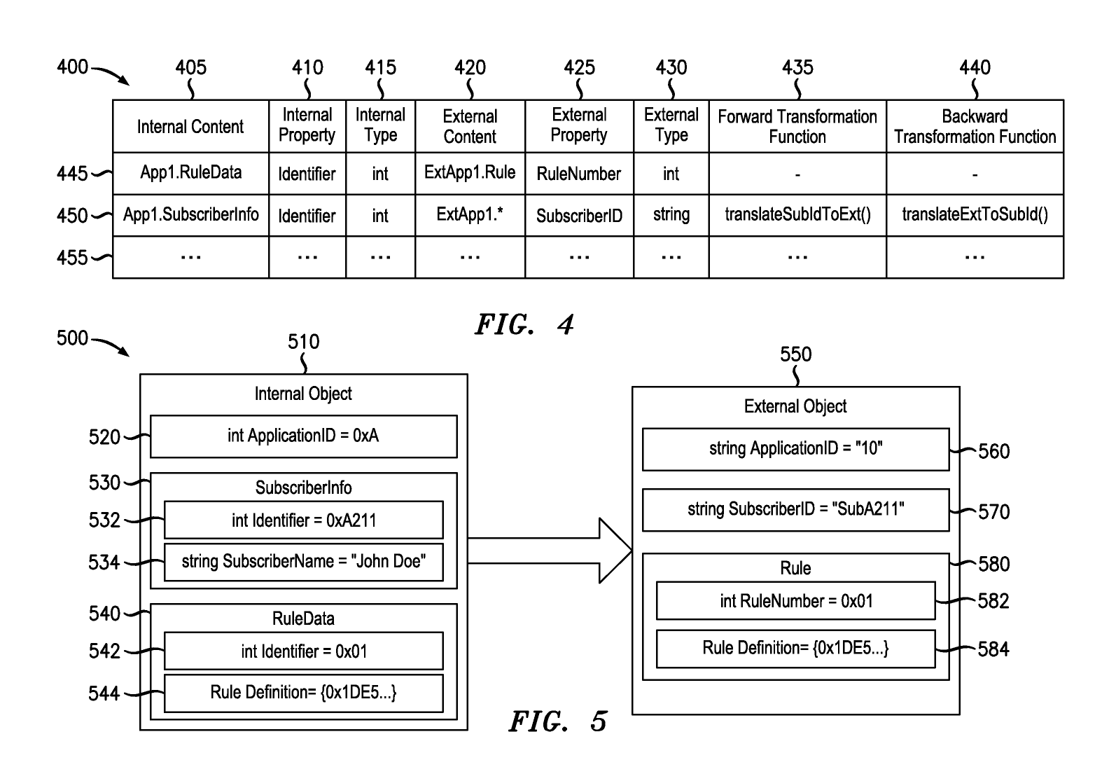

The preregistered translator 233 may perform property translation from one object to another based on translation bindings stored in the translation bindings storage 243. The translation bindings storage 233 may be a device that stores bindings previously-registered by a user or administrator of the device, for example, via a user interface (not shown). For example, the translation bindings may be stored as part of a configuration file. The translation bindings storage 233 may include a machine-readable storage medium such as read-only memory (ROM), random-access memory (RAM), magnetic disk storage media, optical storage media, flash-memory devices, and/or similar storage media. As will be explained below in connection with the examples of FIG. 4, the bindings stored in the translation bindings storage 233 may include mappings between properties of internal objects and properties of external objects along with transformation functions to be applied to the values of such properties. In translating a property, the pre-registered translator may search the translation bindings storage 243 for a matching binding and, if a binding is found, translate the property as specified by the binding. Otherwise, the pre-registered translator may ignore the property and not perform any translation. Thereafter, the property may be left untranslated and therefore not included in the translated object or may be translated by another method of the universal translator.

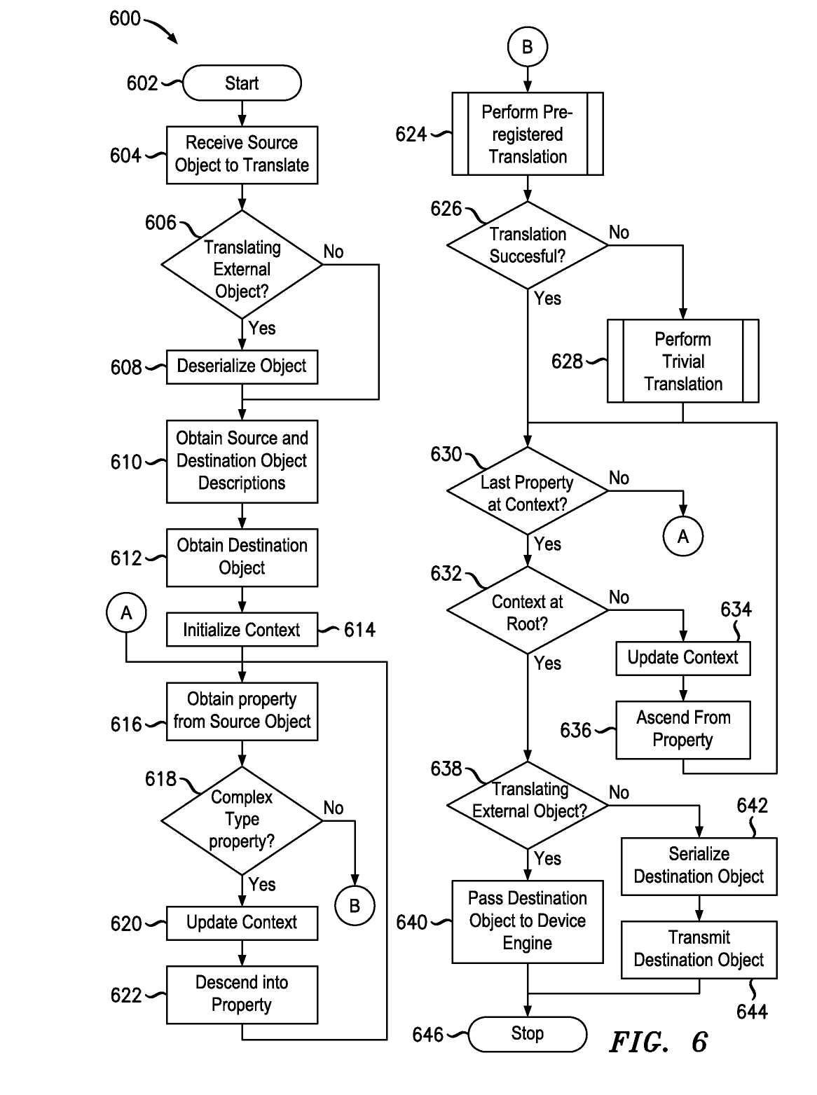

The trivial translator 237 may perform property translation from one object to another based on matching properties contained in the associated object descriptions stored in the object description storage 247. The object description storage 247 may be a device that stores meta-data descriptive of the various internal objects and external objects used in translation. For example, in embodiments where the objects undergoing translation are Java objects, the meta-data may include java class data stored in non-heap memory. Various other types of metadata for describing an object's contents and structure in other embodiments will be apparent. The object description storage 247 may include a machine-readable storage medium such as read-only memory (ROM), random-access memory (RAM), magnetic disk storage media, optical storage media, flash-memory devices, and/or similar storage media. As will be explained in further detail below with respect to FIG. 5, the object descriptions may describe a number of properties contained in the various objects along with their data types and location within the object hierarchy (e.g., nesting within other properties). In translating a property, the trivial translator 237 may locate a matching property within the destination object at the same location within the object hierarchy. Two properties may match, for example, when the properties carry identical or, in some embodiments, similar property names. For example, in some embodiments, the trivial translator 237 may compare “getter” and “setter” property names carried by a Java class. Upon finding such a match, the trivial translator 237 may copy the value from the source property to the destination property. Where the object descriptions identify the source and destination properties as carrying different data types, the trivial translator may perform simple data transformations such as, for example, translating an integer to a string. Various other simple data type transformations will be apparent.

FIG. 3 illustrates an exemplary hardware diagram of a device 300 including a universal translator. The exemplary device 300 may correspond to the device 200 of FIG. 2, the device A 110, or the device B 120 of FIG. 1. As shown, the hardware device 300 may include a processor 310, memory 320, user interface 330, network interface 340, and storage 350 interconnected via one or more system buses 360. It will be understood that FIG. 3 constitutes, in some respects, and abstraction and that the actual organization of the components of the hardware device 300 may be more complex than illustrated.

The processor 310 may be any hardware device capable of executing instructions stored in memory 320 or storage 350. As such, the processor may include a microprocessor, field programmable gate array (FPGA), application-specific integrated circuit (ASIC), or other similar devices.

The memory 320 may include various memories such as, for example L1, L2, or L3 cache or system memory. As such, the memory 320 may include static random access memory (SRAM), dynamic RAM (DRAM), flash memory, read only memory (ROM), or other similar memory devices.

The user interface 330 may include one or more devices for enabling communication with a user such as an administrator. For example, the user interface 330 may include a display, a mouse, and a keyboard for receiving user commands.

The network interface 340 may include one or more devices for enabling communication with other hardware devices. For example, the network interface 340 may include a network interface card (NIC) configured to communicate according to the Ethernet protocol. Additionally, the network interface 340 may implement a TCP/IP stack for communication according to the TCP/IP protocols. Various alternative or additional hardware or configurations for the network interface 340 will be apparent.

The storage 350 may include one or more machine-readable storage media such as read-only memory (ROM), random-access memory (RAM), magnetic disk storage media, optical storage media, flash-memory devices, or similar storage media. In various embodiments, the storage 350 may store instructions for execution by the processor 310 or data upon with the processor 310 may operate. For example, the storage may store universal translator instructions 360, including trivial translation instructions 362 and pre-registered translation instructions 364, for use in translating between external and internal data objects. For example, the universal translator instructions may be used by the processor 310 translate an external object received via the network interface 340 into an internal object for further operations by the processor 310. The storage 350 may also include translation bindings 370 or object descriptions 380 for use by the universal translator instructions 360. It will be apparent that various information described as stored in the storage 350 may be additionally or alternatively stored in the memory 320. For example, the universal translator instructions may be stored in both the memory 320 and the storage 350, while the object descriptions may only be stored in memory 320. Various other arrangements will be apparent.

FIG. 4 illustrates an exemplary data arrangement 400 for storing translation bindings. The data arrangement 400 may reflect contents of the translation bindings storage 243 or translation bindings 370. It will be understood that the exemplary data arrangement 400 may be an abstraction and that data may be stored in a variety of manners such as, for example, arrays, lists, trees, a flat configuration file, or other data structures known to those of skill in the art. The data arrangement 400 may include a internal context field 405, a internal property field 410, a internal type field 415, an external context field 420, an external property field 425, an external type field 430, a forward translation function field 435, and a backward transformation function 440.

Each binding may be used in both directions; the same binding may be used to translate from an internal object to an external object and from an external object to an internal object. As such, each binding may include two sets of data describing the two sides of the translation. Depending on the direction of translation, one of the sets may correspond to the source object while the other set may correspond to the destination object.

The internal context field 405 and external context field 420 may store an indication of the location of a property within the parent object to which a record corresponds. When the context field 405, 420 corresponds to the source object for translation, the context field 405, 420 may indicate where the associated property must be located for the binding to match. When the context field 405, 420 corresponds to the destination object, the context field 405, 420 may indicate the location within the destination object hierarchy where the translated property should be placed.

The internal property field 410 and external property field 425 may store an indication of a property name to which a record corresponds. When the property field 410, 425 corresponds to the source object for translation, the property field 410, 425 may indicate from which property (at the appropriate location as indicated by the context field 405, 420) of the source object data is to be read. When the property field 410, 425 corresponds to the destination object, the property field 410, 425 may indicate to which property (at the appropriate location as indicated by the context field 405, 420) of the destination object data is to be set.

The internal type field 415 and external type field 430 may store an indication of a data type associated with the properties to which a record corresponds. Such type fields 415, 430 may be used to determine when data cannot simply be copied from one property to another. For example, where the types do not match, the translator may perform a transformation on the data before setting the property of the destination object. It will be understood that, while various examples disclosed herein relate to simple data types such as integers and strings, properties of different types may also be translated by the preregistered translator or trivial translator. For example, both the preregistered translator and trivial translator may enable translation to or from “generic” or “template” types wherein, prior to instantiating an object, an associated class is completed by “filling in” one or more sub-property types with additional types specified by a programmer. For example, a generic or template “List” type may be completed as a “List of Integers” prior to instantiation as a first property and later completed as a “List of Strings” prior to instantiation as a second property. In the case of the preregistered translator, a binding may specify a transformation function for translating to or from such a generic or template type, as will now be described.

The forward transformation function field 435 and backward transformation function field 440 may store references to various functions used in performing transformations that are more complex than simple data type transformations. Such transformation functions may be provided by a user and may perform tasks such as data type transformation, removal or addition of data, and condition evaluation. In various embodiments, the transformation functions may receive parameters or otherwise be provided with access to additional data other than the source property data. For example, the transformation function may access a source or destination context and utilize such information to determine how the data should be transformed. In some embodiments, the transformation function may be provided with “enriched context information” to include the context information, the object referenced by the context, and any parent context information. In this manner, the transformation function may be provided with access to the parent object that contains the source property or destination property and may thereby base transformation on other properties and associated values of these parent objects.

As an example, binding 445 may indicate that, when translating an internal object to an external object, the integer data carried by the source property “Identifier,” when located in an object for application “App1” inside the complex property “RuleData,” should be simply copied to the integer property “RuleNumber” of the “ExtApp1” external object within the “Rule” complex property. Similarly, the binding 445 may also indicate that, when translating from an external object to an internal object, the value of “RuleNumber” at context “ExtApp1.Rule” should be copied to the property “Identifier” at context “App1.RuleData.” The binding may not specify any transformation functions and, thereby, indicate that no transformation function should be applied to the data in either translation direction.

As another example, the binding 450 illustrates the utility of context information. While the internal property name “Identifier” is the same as that of record 445, the internal context points instead to “App1.SubscriberInfo,” indicating that the binding only applies to the “Identifier” property when that property is contained within the object associated with “App1” within the “SubscriberInfo” complex property. The binding 450 also illustrates the use of wildcards within the context path. As such, the binding may apply to an external property “SubscriberID” no matter where the property lies within the object associated with the application “ExtApp1.” The binding 450 may also specify transformation functions for transforming between the respective integer and string data in both translation directions. The data arrangement 400 may include numerous additional records 455.

It will be understood that various additional or alternative fields may be used in defining a translation binding. For example, a binding may include an identification of the ultimate source or destination device associated with an external object, such as a device identification or an interface version of the other end device. In this manner, different bindings may be defined for different devices with which the present device is in communication. As another example, the source type field 415 and external type field 430 may not be present and, instead, the translator may refer to object descriptions to identify data type mismatches. Various other modifications will be apparent.

FIG. 5 illustrates an exemplary translation 500 from an internal object 510 and an external object 550. As shown, the internal object 510 and external object 550 may be associated with both descriptive meta-data and actual values. It will be understood that the meta-data and values may not be so arranged within memory and, instead, may be separated from each other between an instantiated object and class data. As such, it will be understood that the depictions of the internal object 510 and external object 550 may constitute an abstraction.

As shown, the internal object 510 may include a ApplicationID property 520 set to an integer value of “0xA,” a SubscriberInfo complex property 530, and a RuleData complex property 540. The SubscriberInfo complex property 530 may include a Identifier property 532 set to an integer value of “0xA211” and a SubscriberName property set to a string value of “John Doe.” The RuleData complex property 540 may include a Identifier property set to an integer value of “0x01” and a Definition property set to a “Rule” data type value (expressed as raw binary data) of “{0x1DE5 . . . }.”

The external object 550 may be generated as a translation of the internal object 510 based on the bindings of data arrangement 400 and meta-data descriptive of both the internal object 510 and the external object 550. The external object 550 may include a ApplicationID property set to a string value of “10.” Such value may be set based on a trivial translation of the ApplicationID property 520 of the internal object 520. For example, the translator may determine that the context and name of the two properties 520, 560 match and that the value should therefore be copied from property 520 to property 560. The meta-data for the two objects 510, 550 may indicate that the data types of the properties 520, 560 do not match and, as such, the translator may translate the integer value “0xA” to the string value “10” prior to setting the destinations property 560.

The external object 550 may also include a SubscriberID property 570 that includes the value “SubA211.” Such value may have been copied based on the binding 450. Specifically, the translator may have determined that the Identifier property 532 within the SubscriberInfo complex property 530 matched the internal property field 410 and internal context property 405 of the binding 450. Then, based on the binding 450, the translator may have called a function “translateSubldToExt( )” to convert the integer value “0xA211” to a string and then append the string “Sub” to the beginning thereof. Then, based on the external context field 420 and external property field 425 of the binding 450, the translator may have placed the transformed value into the SubscriberID property 570 at the top level of the external object 550.

The external object 550 may also include a Rule complex property 580, including a RuleNumber property 582 and a Definition property 584. The RuleNumber property 582 may be set based on the binding 445. The Definition property 584 value may be set based on a trivial translation due to the matching context and property names of the Definition property 544 of the internal object 510 and the Definition property 584 of the external object 550, as those properties are described by the meta-data associated with the two objects 510, 550.

It is worth noting that the external object 550 may not carry any property that indicates a subscriber name similar to the SubscriberName property 534 of the internal object 510. This may be because no binding may be defined for the SubscriberName property 534 and because the metadata descriptive of the external object 550 may not include any context and property that matches the SubscriberName property 534. In this manner, data contained by the internal object 510 may be withheld from external devices receiving the external object 550.

FIG. 6 illustrates an exemplary method 600 for translating an object. The method 600 may be performed by the components of a device such as a universal translator 230 or a processor 310 and may be implemented by instructions encoded on a machine-readable storage medium, such as the universal translator instructions 360.

The method 600 may begin in step 602 and proceed to step 604 where the device may receive a source object to be translated. For example, the device may receive an internal object from the device engine to be translated prior to transmittal to an external device or the device may receive an external object via a network interface for translation before being processed by the device engine. In step 606, the device may determine whether the source object is an external object, thereby indicating that the received object is currently serialized. If so, the device may deserialize the object in step 608.

It will be understood that, in various embodiments, translation may be performed on a serialized object. Modifications to the method 600 for switching the order of serialization and translation will be apparent. For example, steps 606 and 638 may be switched to determine whether the source object is an internal object, step 608 may be changed to serialize the object, step 642 may be removed, and a new step may be performed before step 640 to deserialize the translated object.

After deserialization in step 608 or a determination in step 606 that the object is not currently serialized, the method 600 may proceed to 610 where the device may obtain source and destination object descriptions. Such descriptions may include, for example, class metadata descriptive of the structure and properties of the source and destination objects. The destination object may be determined according to any method known to those of skill in the art such as, for example, a mapping of the source object to desired destination object, or a mapping of the source object, application, and version to the desired destination object.

In step 612, the device may obtain a destination object into which the source object may be translated. For example, the device may use the destination object description obtained in step 610 to create a new object instance. In various embodiments, the device may be able to translate into an existing object. In such embodiments, step 612 may include locating an existing object into which the source object may be translated. For example, while translating an external object that represents an update to a database record, the device may retrieve an internal object that represents the current version of a database record that the external object identifies for update. In this manner, the process of updating an existing object may be streamlined; instead of translating an external object and then merging the translated object into the existing object, the two steps may be combined.

In step 614, the device may initialize a context to be tracked during translation. The initialized context may indicate a current location within the source object hierarchy being processed and, upon initialization, may simply indicate that the method is currently processing a “root” level of the source object or may specify an application with which the source object is associated. Next, in step 616, the device may obtain a property from the source object to be translated. In step 618, the device may determine whether the property is a “complex” type property. As will be understood, a complex property may serve as a container that stores additional properties. If the current property is complex, the device may update the context in step 620 to include an indication of the complex property, thereby indicating that the next properties to be processed are nested within the complex property. Then, in step 622, the device may descend into the complex property and loop back to step 616 where the device will choose a next property to evaluate from within the complex property. In various alternative embodiments, the method 600 may be implemented as a recursive algorithm. In such embodiments, step 622 may involve making a recursive call to method 600 and passing the current context to the method 600.

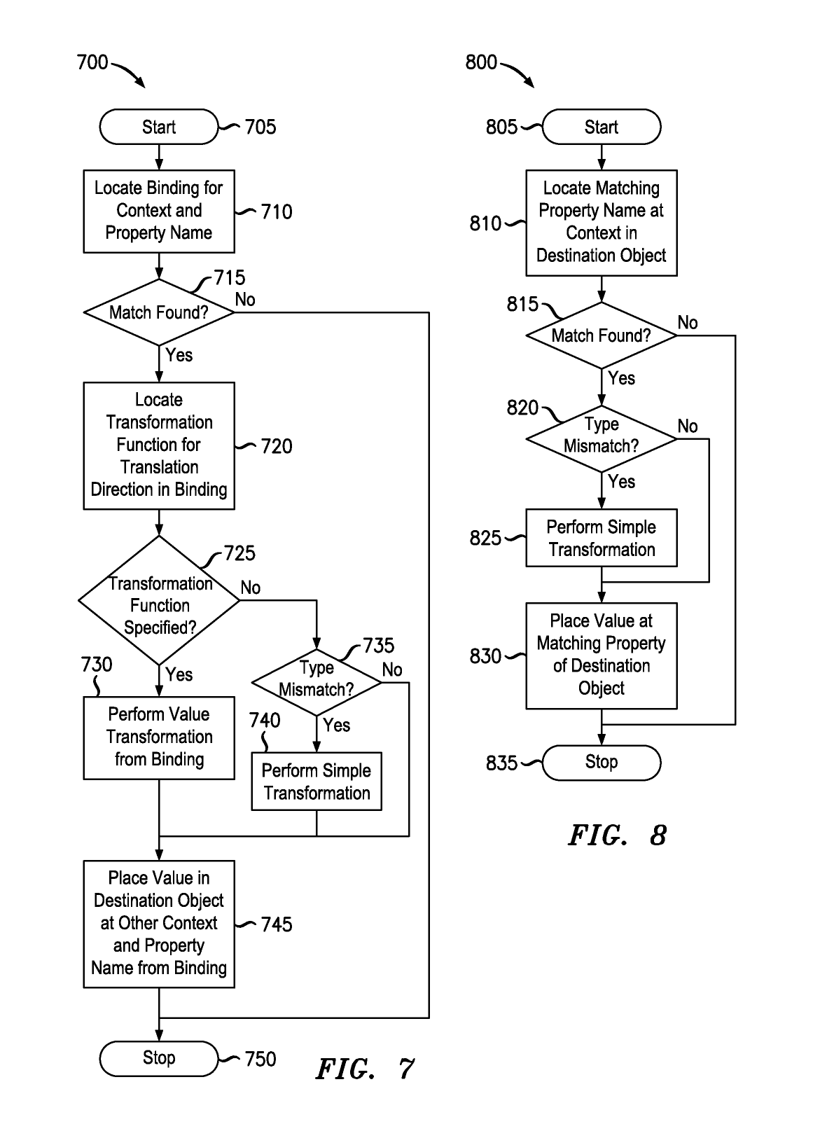

When the device locates a non-complex property, the method may proceed from step 618 to step 624 where the device may attempt to perform a pre-registered translation. An exemplary method for performing pre-registered translation will be described in greater detail below with respect to FIG. 7. In step 626, the device may determine whether the property was successfully translated in step 624 by, for example, reading a result code returned from a pre-registered translation subroutine or by determining that the destination object has been changed. If the pre-registered translation step 624 did not perform any translation (thereby indicating that no binding existed for the current property), the method 600 may proceed to step 628 where the device may attempt to perform a trivial translation. An exemplary method for performing trivial translation will be described in greater detail below with respect to FIG. 8. Regardless of the outcome of the trivial translation step 628, the method 600 may proceed to step 630 where the device may determine whether additional properties remain to be translated at the current context. If so, the method may loop back to step 616 where the next property may be processed. Otherwise, the method 600 may proceed to step 632 where the device may determine whether the context is currently at the root level, thereby indicating that the last property of the source object has been processed. If the context is not at the root level, the device may, in step 634, update the context to remove the indication of the current lowest level, thereby indicating that the next property to be processed will be located outside of the current complex property. Next, in step 636, the device may ascend from the current complex property and resume processing the properties at the next highest level within the source object hierarchy. In embodiments wherein method 600 is implemented as a recursive method, step 636 may include returning from a recursive function call. Next, the method may loop back to step 630, where the device will determine whether the next highest level included any more properties to be processed.

Once all properties within the object and at all hierarchical levels of the object have been processed, the device may determine at step 632 that the context is currently at the root level. The method may then proceed to step 638 where the device may, again, determine whether the source object is an external object. If so, the device may, in step 640, pass the translated internal object to the device engine for further processing. It will be understood that, in various embodiments, “passing the destination object” may simply involve keeping the destination object available for additional processing by the same processor that performed the translation.

If, on the other hand, the source object was an internal object, the device may proceed to serialize the translated internal object in step 642 and then transmit the serialized object toward its destination device in step 644. The method may then proceed to end in step 646.

FIG. 7 illustrates an exemplary method 700 for performing a pre-registered translation. The method 700 may be performed by the components of a device such as a universal translator 230 or a processor 310 and may be implemented by instructions encoded on a machine-readable storage medium, such as the universal translator instructions 360 or the pre-registered translation instructions 364. The method 700 may correspond to step 624 of the method 600.

The method 700 may begin in step 705 and proceed to step 710 where the device may attempt to locate a binding for the current context and property name. For example, where the source object is an internal object, the device may search for a binding including an internal context and internal property name that matches the current context and property name. Similarly, where the source object is an external object, the device may search for a binding including an external context and external property name that matches the current context and property name. In step 615, the device may determine whether any matching binding was located. If no binding is available, then the device may determine that no pre-registered translation will be performed and the method 700 may proceed to end in step 750. The device may then proceed to attempt trivial translation of the property according to method 600.

If, however, the device locates a matching binding, the method may proceed to step 620. There, the device may determine whether the binding specifies a transformation function for the direction of the current translation. For example, if the source object is an internal object, the device may determine whether the binding identifies a forward transformation function. If an appropriate transformation function is identified, the device may perform value transformation using the transformation function in step 730. The transformation function may operate on the value of the source property to generate a modified value to be placed in the destination object. In various embodiments, the transformation function may be provided with access to additional information, such as the current context or access to the parent object itself. In this manner, the flexibility of the transformation function may be expanded to enable more complex logic and reusability to the transformation functions.

If no transformation function is specified for the current transformation direction, the method 700 may proceed to step 735, where the device may determine whether the source property and associated destination property have matching types such that the value may simply be copied over. If there is a type mismatch, the device may perform a simple data type transformation on the source property value. For example, the device may convert an integer value to a string or floating point value. If the types match, on the other hand, the method 700 may proceed directly to step 745 where the unmodified source value may be used. As another example, where the source or destination property is a generic or template type, the device may refer to metadata associated with the template or generic property to transform from one property to another in a manner similar to that described herein with respect to trivial translation.

In step 745, the device may place the value as transformed or as originally stored by the source property, depending on the path taken through steps 725-740, into the destination property at the destination context as specified by the binding. The method 700 may then proceed to end in step 750.

FIG. 8 illustrates an exemplary method 800 for performing a trivial translation. The method 800 may be performed by the components of a device such as a universal translator 230 or a processor 310 and may be implemented by instructions encoded on a machine-readable storage medium, such as the universal translator instructions 360 or the trivial translation instructions 362. The method 800 may correspond to step 628 of the method 600.

The method 800 may begin in step 805 and proceed to step 810 where the device may attempt to locate a property within the destination object that has a matching name and context to the current source property. For example, the device may analyze metadata associated with the destination object for such a matching property. In step 815, the device may determine whether such a match was located. If not, the device may determine that no trivial translation will be performed and the method 800 may proceed to end in step 835. Otherwise, the device may, in step 820, determine whether the data types associated with the source and destination properties match. This determination may be made by comparing the meta-data associated with the two objects. If the types already match, the method 800 may proceed directly to step 830. Otherwise, if there is a type mismatch, the device may perform a simple transformation to convert the value of the source property to the data type of the destination property. Then, in step 830, the device may place the modified or unmodified property (depending on the path taken through steps 820-825) in the matching destination property. The method may then proceed to end in step 835.

According to the foregoing, various embodiments enable a universal translator to be utilized for many different object translations. By employing a robust, meta-data-based, and context sensitive trivial translation, a universal translator may adapt to and translate virtually any pair of similar objects. Further, by additionally utilizing preregistered translation bindings, the universal translator may be extended to additionally handle special case translations that are not already provided for by the trivial translation. Additional benefits will be apparent in view of the foregoing.

It should be apparent from the foregoing description that various exemplary embodiments of the invention may be implemented by hardware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a networked device for translating information used in communicating with another device, the method comprising:
receiving a first object to be translated, wherein the first object has a first type;
obtaining a second object having a second type that is different from the first type;
identifying a first property of the first object, wherein the first property is associated with a first location within a hierarchy of the first object;
identifying a second property of the second object;
setting a value of the second property based on a value of the first property when:
a name of the first property matches a name of the second property, and
the first location matches a second location of the second property within a hierarchy of the second object; and
making the second object available to a receiving device.

2. The method of claim 1, wherein:
the receiving device includes another device in communication with the networked device,
the first type is a type used internally by a processor of the networked device, and
making the second object available comprises transmitting the second object to the other device.

3. The method of claim 1, wherein:
the receiving device includes a processor of the networked device, and
the second type is a type used internally by the processor.

4. The method of claim 1, wherein setting a value of the second property based on a value of the first property comprises:
identifying a first data type of the first property;
identifying a second data type of the second property; and
converting the value of the first property to the second data type when the first data type and the second data type do not match.

5. The method of claim 1, wherein:
obtaining the second object comprises obtaining a second object including a previous value for the second property, and
setting a value of the second property comprises overwriting the previous value.

6. The method of claim 1, further comprising:
identifying a third property of the first object;
identifying a translation binding associated with the third property;
identifying, based on the translation binding, a fourth property of the second object, wherein the fourth property does not match the third property; and
setting a value of the fourth property based on a value of the third property.

7. The method of claim 6, wherein:
the translation binding identifies a transformation function, and
setting a value of the fourth property comprises using the transformation function to modify the value of the third property.

8. The method of claim 7, wherein the transformation function accesses at least one property of the first object other than the third property.

9. A networked device for translating information used in communicating with another device, the method comprising:
a network interface;
a memory; and
a processor in communication with the memory and the network interface, the processor being configured to:
receive a first object to be translated, wherein the first object has a first type;
obtain a second object having a second type that is different from the first type;
identify a first property of the first object, wherein the first property is associated with a first location within a hierarchy of the first object;
identify a second property of the second object;
set a value of the second property based on a value of the first property when:
a name of the first property matches a name of the second property, and
the first location matches a second location of the second property within a hierarchy of the second object; and
make the second object available to a receiving device.

10. The networked device of claim 9, wherein:
the receiving device includes another device in communication with the networked device,
the first type is a type used internally by the processor, and
in making the second object available, the processor is configured to transmit the second object to the other device via the network interface.

11. The networked device of claim 9, wherein:
the receiving device includes the processor,
the second type is a type used internally by the processor, and
in making the second object available, the processor is configured to make the second object available comprises placing the second object in the memory for continued use by the processor.

12. The networked device of claim 9, wherein, in setting a value of the second property based on a value of the first property, the processor is configured to:
identify a first data type of the first property
identify a second data type of the second property; and
convert the value of the first property to the second data type when the first data type and the second data type do not match.

13. The networked device of claim 9, wherein:
in obtaining the second object, the processor is configured to obtain a second object including a previous value for the second property, and
in setting a value of the second property, the processor is configured to overwrite the previous value.

14. The networked device of claim 9, wherein the processor is further configured to:
identify a third property of the first object;
identify a translation binding associated with the third property;
identify, based on the translation binding, a fourth property of the second object, wherein the fourth property does not match the third property; and
set a value of the fourth property based on a value of the third property.

15. The networked device of claim 14, wherein:
the translation binding identifies a transformation function, and
in setting a value of the fourth property, the processor is configured to use the transformation function to modify the value of the third property.

16. The networked device of claim 15, wherein the transformation function accesses at least one property of the first object other than the third property.

17. A non-transitory machine-readable storage medium encoded with instructions for execution by a networked device for translating information used in communicating with another device, the medium comprising:
instructions for receiving a first object to be translated, wherein the first object has a first type;
instructions for obtaining a second object having a second type that is different from the first type;
instructions for identifying a first property of the first object, wherein the first property is associated with a first location within a hierarchy of the first object;
instructions for identifying a second property of the second object;
instructions for setting a value of the second property based on a value of the first property when:
a name of the first property matches a name of the second property, and
the first location matches a second location of the second property within a hierarchy of the second object; and
instructions for making the second object available to a receiving device.

18. The non-transitory machine-readable storage medium of claim 17, wherein the instructions for setting a value of the second property based on a value of the first property comprise:
instructions for identifying a first data type of the first property
instructions for identifying a second data type of the second property; and
instructions for converting the value of the first property to the second data type when the first data type and the second data type do not match.

19. The non-transitory machine-readable storage medium of claim 17, wherein:
the instructions for obtaining the second object comprise instructions for obtaining a second object including a previous value for the second property, and
the instructions for setting a value of the second property comprise instructions for overwriting the previous value.

20. The non-transitory machine-readable storage medium of claim 17, further comprising:
instructions for identifying a third property of the first object;
instructions for identifying a translation binding associated with the third property;
instructions for identifying, based on the translation binding, a fourth property of the second object, wherein the fourth property does not match the third property; and
instructions for setting a value of the fourth property based on a value of the third property.

21. The non-transitory machine-readable storage medium of claim 20, wherein:
the translation binding identifies a transformation function, and
the instructions for setting a value of the fourth property comprise instructions for using the transformation function to modify the value of the third property.

22. The non-transitory machine-readable storage medium of claim 21, wherein the transformation function accesses at least one property of the first object other than the third property.
